(19) United States
(12) Patent Application Publication
(10) Pub. No.: US 2003/0169280 A1
(43) Pub. Date: Sep. 11, 2003

(54) Method and apparatus of scrolling a screen display corresponding to the movement of a cursor

(75) Inventor: Wenhao Hsieh, Taipei Hsien (TW)

Correspondence Address: BACON & THOMAS, PLLC, 625 SLATERS LANE, FOURTH FLOOR, ALEXANDRIA, VA, 22314

(73) Assignee: Kinpo Electronics, Inc., Taipei (TW)

(21) Appl. No.: 10/092,913

(22) Filed: Mar. 8, 2002

(51) Int. Cl. G09G 5/00

(52) U.S. Cl. 345/684

(57) ABSTRACT

A method and apparatus for scrolling a display, the scrolling corresponding to the movement of a cursor, which scrolling can be performed on an information apparatus, such as a set top box (STB). The present invention enables a user to control the cursor on the screen via an input device so the cursor moves in an active window having display content. When the cursor is moved to the edge of the window, the window is scrolled to change the displaying region, and the cursor is moved sequentially to about the middle position of the new window.

### BACKGROUND OF THE INVENTION

1. Field of the Invention

The present invention relates to a method and apparatus for scrolling a display, the scrolling corresponding to the movement of a cursor and, more particularly, to performing such scrolling on an information apparatus field such as set top box (STB).

2. Description of the Related Art

The conventional STB is connected to a television. A user can surf on the Internet via a network interface provided by the STB and watch TV programs via a TV tuner. The user can choose to watch TV or to surf on the Internet. The STB provides network connectivity, enabling the user to surf on the Internet without the need of a personal computer. The STB serves as a multi-function work platform, which is a great improvement for information devices.

However, when the prior art STB is serving as an Internet module and a user wants to scroll a displayed web page, the user has to move the cursor to a scroll bar and then click on a scroll arrow to cause the displayed web page to move upward or downward, which is very inconvenient for the user.

### SUMMARY OF THE INVENTION

The object of the present invention is to provide an easy-to-use operating interface for a user.

With regard to this objective, a method of scrolling a display according to the movement of a cursor is disclosed. The method includes step A: receiving a cursor moving signal; step B: judging if the position of the cursor will be out of the active window; if it is not, proceeding to step C; if it is, proceeding to STEP D; step C: moving the cursor; and step D: scrolling the active window along the moving direction of the cursor. A predetermined scroll distance for step D is a half page, and the cursor will be placed at a middle position of the window, which is then scrolled according to the movement of the cursor.

The present invention further provides a set top box for receiving networking signals to link to a website and outputting an image signal to a television, and a user may view the content of the website via the television. The set top box provides an input device for the user to control the movement of a cursor in an active window display. The set top box provides the following functionality: condition 1: moving the cursor if the sequential movement of the cursor will not be out of the active window; condition 2: scrolling the window display along the movement of the cursor if the cursor will not be out of the active window. Condition 2 further includes two conditions: the scrolling distance of the window is equal to a preset value when the remaining content exceeds the size of display; and the scrolling distance of the window is less than the preset value when the remaining content is less than the size of the display.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of the environment according to the present invention.

FIG. 2 is the hardware structure of a set top box.

FIG. 3 is a flowchart of an embodiment of the present invention.

FIG. 4 is a first drawing of the continuous screen display of the embodiment according to the present invention.

FIG. 5 is a first drawing of a series of screen displays of the embodiment according to the present invention.

FIG. 6 is a second drawing of a series of screen displays of the embodiment according to the present invention.

FIG. 7 is a third drawing of a series of screen displays of the embodiment according to the present invention.

FIG. 8 is a schematic drawing of an alternative embodiment according to the present invention.

### DETAILED DESCRIPTION OF THE PREFERRED EMBODIMENT

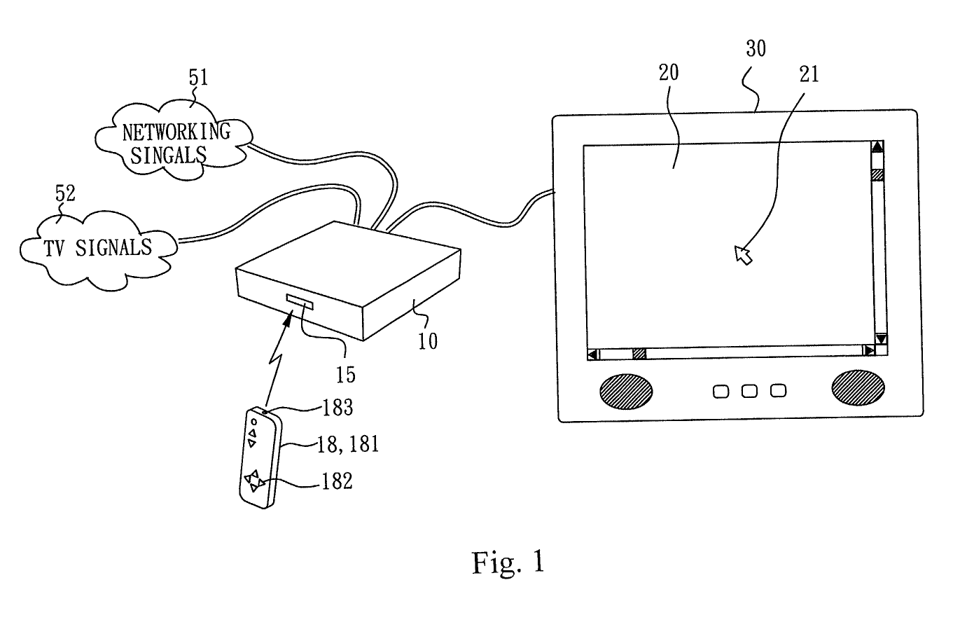

Please refer to FIG. 1. FIG. 1 is a schematic drawing of the environment according to the present invention. A set top box (STB) 10 is connected to a television 30 and able to receive a network signal 51 and a television signal 52. A user can watch TV programs and surf on the Internet via the television 30. An input device 18 with an infrared transmitter 183 is used for providing control instructions to an infrared receiver 15 of the STB 10. Generally, the input device 18 is a remote control 181 or a keyboard. As shown in FIG. 1, the remote control 181 includes a cursor direction button 182 and the infrared transmitter 183. The infrared light sent by the infrared transmitter 183 is received by the infrared receiver 15 of the STB 10.

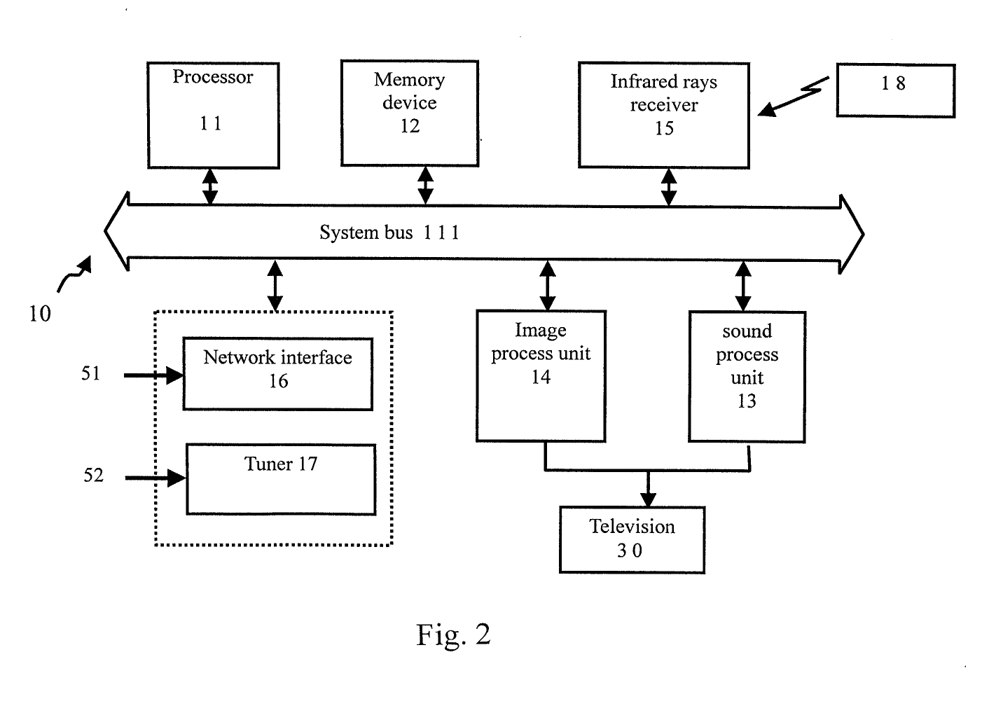

Please refer to FIG. 2. FIG. 2 illustrates the hardware structure of a set top box. Many components of the STB 10 are similar to those found in a typical computer. The STB 10 comprises a processor 11, a system bus 111, a memory device 12 (such as DRAM, a hard disk, a memory card), a sound processing unit 13, an image processing unit 14, the infrared receiver 15, a network interface 16, a tuner 17 and the input device 18. Networking signals 51 (such as from Internet) are received by the network interface 16, and TV tuner signals 52 are received by the tuner 17. However, in some cases, both the network signals 51 and the TV signals 52 are sent to the STB 10 via an identical cable. Since the characteristics of the present invention are not concerned with the particular hardware characteristics of the STB 10, there will be no more description of the hardware and associated functionality of the STB 10.

A characteristic of the STB 10 is that the user can control the movement of a cursor 21 via the input device 18, and so the cursor 21 moves within an active window 20 of a website. The user can utilize the cursor 21 to scroll the active window to change the content of the displaying region of the window 20. In the embodiment, the size of the window 20 is identical to the size of the screen of the television 30. However, the size of the window 20 on the screen of the television 30 is adjustable, or there may be a plurality of windows 20.

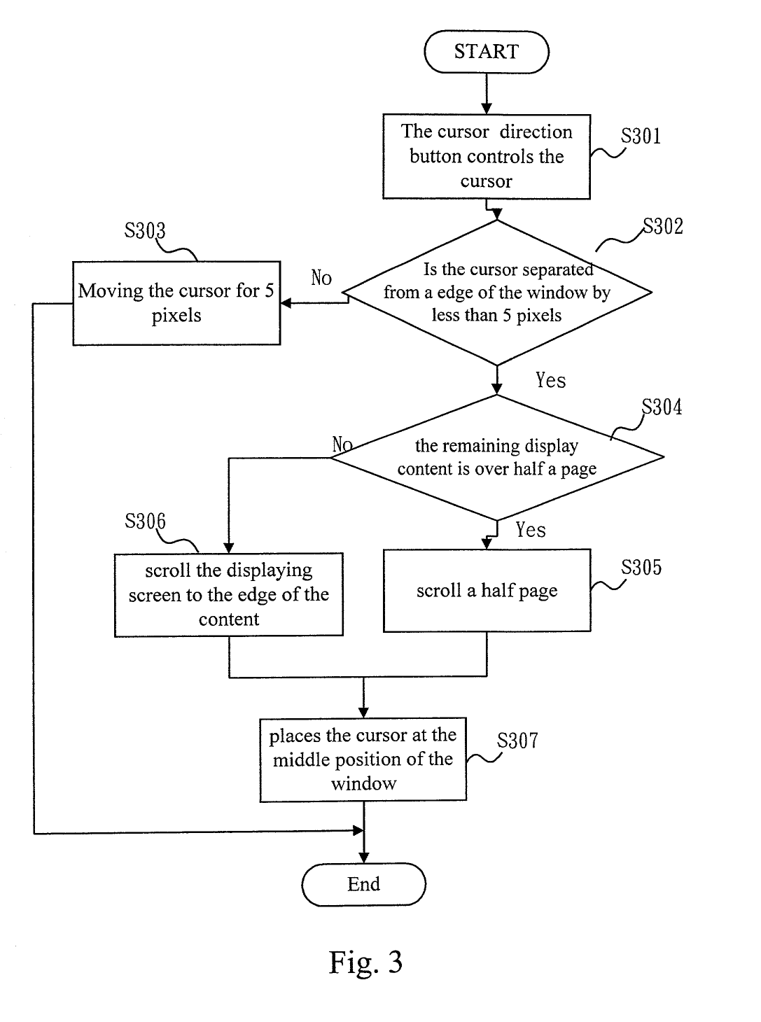

Please refer to FIG. 3. FIG. 3 is a flowchart of an embodiment of the present invention. The method of moving the cursor in the window 20 is shown in FIG. 3. First, the user uses the cursor direction button 182 on the remote control 18 to control the cursor 21 to move in various directions such as up, down, left and right (step 301). The command signal is sent to the infrared receiver 15 of the STB 10 via the infrared transmitter 183, and is then processed by the STB 10. In the embodiment, the infrared transmitter 183 utilizes the Information Data Association (IDA) transmission standard and a PS2 interface to connect to the STB 10. The processor 11 converts a scan code transmitted from the infrared transmitter 183 to a key code or a mouse event code, and the STB 10 controls the movement of the cursor 21 on the screen according to the cursor direction button 182 as manipulated by the user. The present invention need not, however, be limited to the above-mentioned input device.

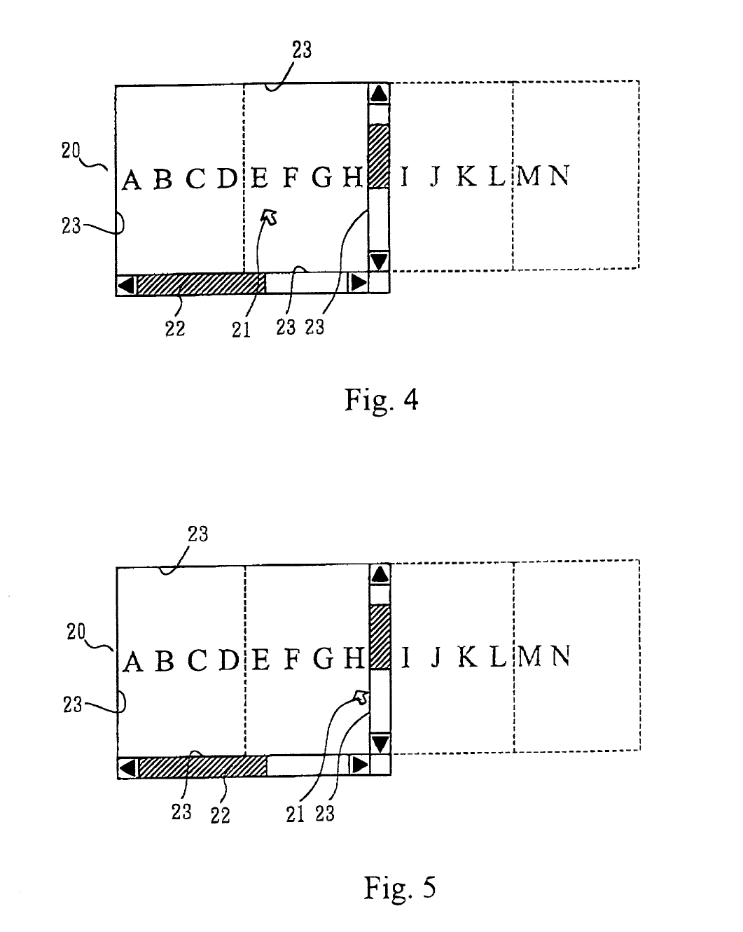

In the embodiment, a predetermined distance for the movement of the cursor 21 is 5 pixels, and a predetermined scroll distance for the display is half a page. The user can setup different predetermined distances for the cursor 21 and different predetermined scroll distances for the display. As shown in FIG. 4, the STB 10 needs to determine whether the cursor is separated from a boundary 23 of the window 20 by less than a fixed distance, such as 5 pixels (step 302), or determine whether the cursor 21 will move out of the window 20. In FIG. 4, the cursor 21 is separated from the boundary 23 of the window 20 by more than 5 pixels; when the user clicks the cursor direction button 182 to move the cursor 21, the cursor 21 will move 5 pixels corresponding to the command (step 303). However, as shown in FIG. 5, when the cursor 21 is separated from the boundary 23 of the window 20 by less than 5 pixels or the command will require the cursor 21 to move out of the window 20, the STB 10 needs to judge whether the remaining display content is over half a page (step 304).

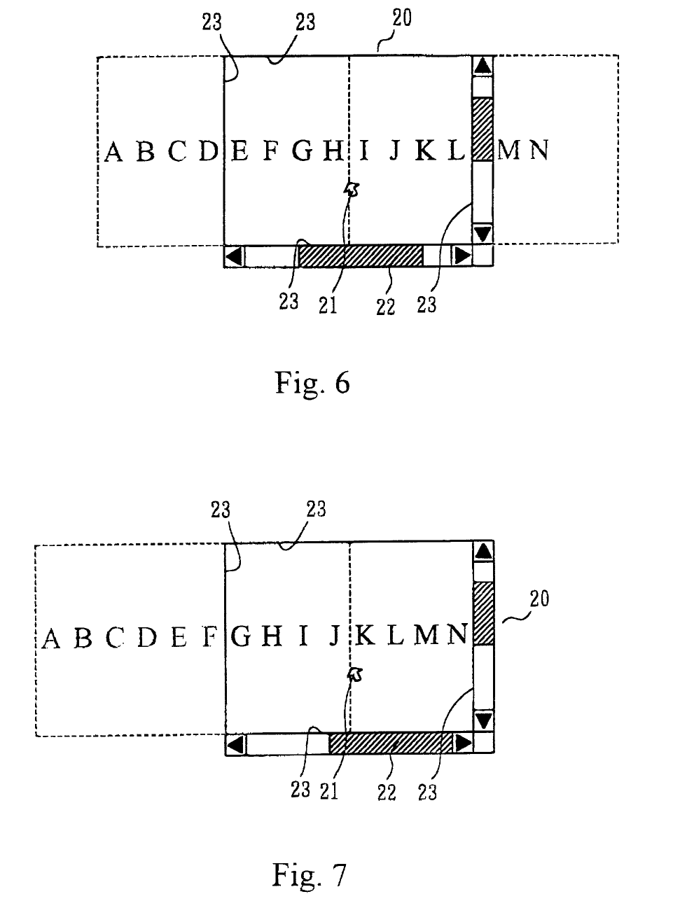

Please refer to FIG. 5. FIG. 5 a first drawing of a series of screen displays of the embodiment according to the present invention. The content of a web page shown in window 20 is “ABCDEFGH”, and the remaining content of the web page at the right side is “IJKLMN”. Since the cursor 21 is separated from the boundary 23 of the window 20 by less than 5 pixels and the remaining content is over half a page, the STB 10 controls a scroll bar 22 to scroll a half page of the displaying screen to right (step 305), so the displayed content will be changed to “EFGHIJKL” as shown in FIG. 6. Furthermore, in order to prevent the cursor 21 from being remaining at the right boundary 23 of window 20, which would cause the display to scroll continuously, the STB 10 places the cursor 21 at the middle position of the window 20 along the moving direction (step 307).

When the user wants to continue browsing the remaining content, the user needs to move the cursor 21 away from the boundary 23 of the window 20 by less than 5 pixels. Since the remaining content “MN” is not enough for a half page, the STB 10 controls the scroll bar 22 to scroll the displaying screen to the edge of the content (step 306), and the displayed content will change to “GHIJKLMN”, as shown in FIG. 7. Finally, the STB 10 places the cursor 21 at the middle position of the window 20 along the moving direction (step 307).

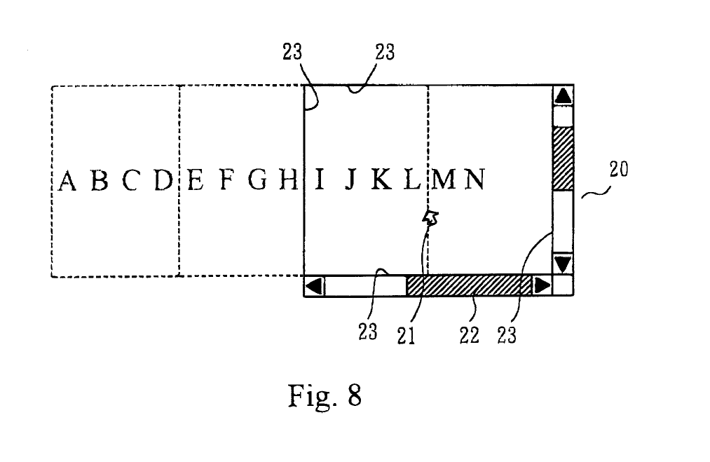

Please refer to FIG. 8. FIG. 8 is a schematic drawing of an alternative embodiment according to the present invention. In this embodiment, the STB 10 controls the scroll bar 22 to scroll a half page of the displaying screen regardless of whether or not the remaining content is sufficient for a half page. As shown in FIG. 8, the right side of the window 20 is a small blank region.

The invention has been described using exemplary preferred embodiments. However, for those skilled in this field the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

What is claimed is:

1. A method of scrolling a display of an information apparatus, the scrolling corresponding to movement of a cursor, a user controlling movement of the cursor in an active window via an input device, the method comprising:
step A: receiving a cursor moving signal;
step B: determining if the position of the cursor will be out of the active window; if it is not, then proceeding the step C, and if it is, then proceeding the step D;
step C: moving the cursor; and
step D: scrolling the active window along the moving direction of the cursor.

2. The method as claimed in claim 1, wherein the scrolling distance in the step D is a half page.

3. The method as claimed in claim 1, further comprising a step after the step D:
placing the cursor at a middle position of the window being scrolled along the movement of the cursor.

4. The method as claimed in claim 1, wherein a preset value regarding a predetermined scrolling distance is provided in the step D, and the scrolling distance of the window in the step D is decided according to the following two situations:
the scrolling distance of the window is equal to the preset value when the remaining content exceeds the size of the display; and
the scrolling distance of the window is less than the preset value when the remaining content is less than the size of the display screen.

5. The method as claimed in claim 4, further comprising a step after the step D:
placing the cursor at a middle position of the window being scrolled along the movement of the cursor.

6. A method of scrolling a screen display of an information apparatus according to movement of a cursor, a user controlling the movement of the cursor in an active window via an input device, the method comprising:
step A: receiving a cursor moving signal;
step B: determining if the position of the cursor is within a predetermined region of the active window; if it is not, then proceeding the step C; and if it is, then proceeding the step D;
step C: moving the cursor; and
step D: scrolling the active window along the moving direction of the cursor.

7. The method as claimed in claim 6, wherein the scrolling distance in the step D is a half page.

8. The method as claimed in claim 6, further comprising a step after the step D:
placing the cursor at a middle position of the window being scrolled along the movement of the cursor.

9. The method as claimed in claim 6, wherein a preset value regarding a predetermined scrolling distance is provided in the step D, and the scrolling distance of the window in the step D is decided according to the following two situations:
the scrolling distance of the window is equal to the preset value when the remaining content exceeds the size of display; and
the scrolling distance of the window is less than the preset value when the remaining content is less than the size of the display.

10. The method as claimed in claim 10, further comprising a step after the step D:
placing the cursor at a middle position of the window being scrolled along the movement of the cursor.

11. A set top box for receiving network signals to link to a website and outputting an image signal to a television, a user capable of viewing content of the website via the television, the set top box providing an input device for the user to control movement of a cursor in an active window display, the set top box comprising the following conditions:
condition 1: moving the cursor if the sequential movement of the cursor will not cause the cursor to move out of the active window; and
condition 2: scrolling the window display along the direction of movement of the cursor if the sequential movement of the cursor will cause the cursor to move out of the active window.

12. The set top box as claimed in claim 11, wherein a predetermined scroll distance for condition 2 is a half page.

13. The set top box as claimed in claim 11, wherein in condition 2 after scrolling the window display, the set top box places the cursor at a middle position of the window being scrolled along the movement of the cursor.

14. The set top box as claimed in claim 11, wherein the condition 2 further comprises two conditions:
the scrolling distance of the window is equal to a preset value when the remaining content exceeds the size of the display; and
the scrolling distance of the window is less than the preset value when the remaining content is less than the size of the display.

15. The set top box as claimed in claim 14, wherein a predetermined scroll distance for condition 2 is a half page.

16. The set top box as claimed in claim 11, wherein the input device is a remote control, and the remote control has a cursor direction button for the user to control the cursor.
